(19) United States
(12) Patent Application Publication
(10) Pub. No.: US 2002/0104400 A1
(43) Pub. Date: Aug. 8, 2002

(54) Actuating device for a hood of a motor vehicle

(75) Inventors: Klaus Hillgaertner, Wurmberg (DE); Michael Hubmann, Bad Rappenau (DE)

Correspondence Address: Crowell & Moring, L.L.P., P.O. Box 14300, Washington, DC, 20044-4300, US

(73) Assignee: Dr. Ing. h.c.F. Porsche

(21) Appl. No.: 10/067,375

(22) Filed: Feb. 7, 2002

(30) Foreign Application Priority Data
Feb. 7, 2001 (DE) 100 05 541.2

(51) Int. Cl. F16C 1/12

(52) U.S. Cl. 74/501.6

(57) ABSTRACT

The actuating device for a hood should be designed in such a way that an actuation from the outside for misuse is not possible. For this purpose, the actuating device is equipped with a handle, in which a locking sensing device and a catch element, which is connected with a Bowden cable, are arranged. By pressing the locking sensing device in the direction of the catch element is created a rigid connection between the locking sensing device and the catch element. For this purpose, the actuating sensing device is equipped with a catch nose and the catch element with a catch recess.

### BACKGROUND AND SUMMARY OF THE INVENTION

This application claims the priority of German Patent Document No. 101 05 541.2, filed Feb. 7, 2001, the disclosure of which is expressly incorporated by reference herein.

The invention relates to an actuating device for a hood of a motor vehicle.

DE 37 17 485 A1 discloses a locking arrangement for a front hood of a motor vehicle with a locking member that can swivel between a locking position and a release position. It includes an operating lever, connected to a swiveling lever and having a locking nose, which meshes with a catch recess in the locking position. In the release position, the swiveling lever is unlocked through a remote control, and the operating lever can swivel out of the catch groove.

An object of the invention is to create an actuating device for a hood of a motor vehicle, which prevents the opening of the hood by reaching into the actuating device from the outside.

The object of the invention is achieved with the devices and methods of the present invention.

In accordance with one aspect of the present invention, the benefits of the invention include that an additional locking sensing device is incorporated into the handle for opening the hood, wherein this sensing device has to be pushed by an operator to open the hood.

To that end, the handle includes an integrated locking sensing device, which is arranged in the handle in a swiveling manner and is held in a locking position through a spring device. The locking sensing device is located opposite a catch element, which can mesh with the locking sensing device in an actuating position.

Although it is possible to swivel the handle from outside the vehicle, the locking sensing device cannot mesh easily from the outside with the catch element to form a rigid connection between the handle and the Bowden cable when the device's nose on its free end is not engaged with a catch recess in the actuating position. This prevents an unauthorized actuation of the handle for the purpose of opening the hood from the outside.

In order to prevent an actuation of the locking sensing device for misuse, the locking sensing device is seated flush with the outer surface of the handle when the hood is in the locking position. Additionally, the locking sensing device rests against a stop and is held in by a support device with a spring.

The locking sensing device includes an elongated lever with a swiveling axis in the handle. The catch element is formed by a lever with a seating part. The lever is adjustable on a swiveling axis in the handle and is connected at its free end with the Bowden cable. The catch recess is arranged in a seating part that is mounted to the swiveling axis. The actuating device with the locking sensing device and the catch element is formed by parts that can be manufactured and assembled easily and are arranged in the handle on the swiveling axes.

An example of the invention is shown in the drawings and is described in more detail in the following.

### BRIEF DESCRIPTION OF THE DRAWINGS

FIG. 1 a view of an actuating device with a locking sensing device and a catch element arranged in a handle in a locking position for the hood of a vehicle.

FIG. 2 is a view of the swiveled handle in the locking position of the hood.

FIG. 3 is a view of the handle in the actuating position with the locking sensing device meshed with the catch element.

### DETAILED DESCRIPTION OF THE DRAWINGS

The actuating device 1 comprises basically a handle 2, which is arranged in a trough 3, for example in the A-column, in the interior of the vehicle. This handle 2 is used to open a hood or the like. In the handle 2, a locking sensing device 4 and a catch element 5 are arranged. The catch element 5 is connected with a Bowden cable 6, which leads to the hood lock.

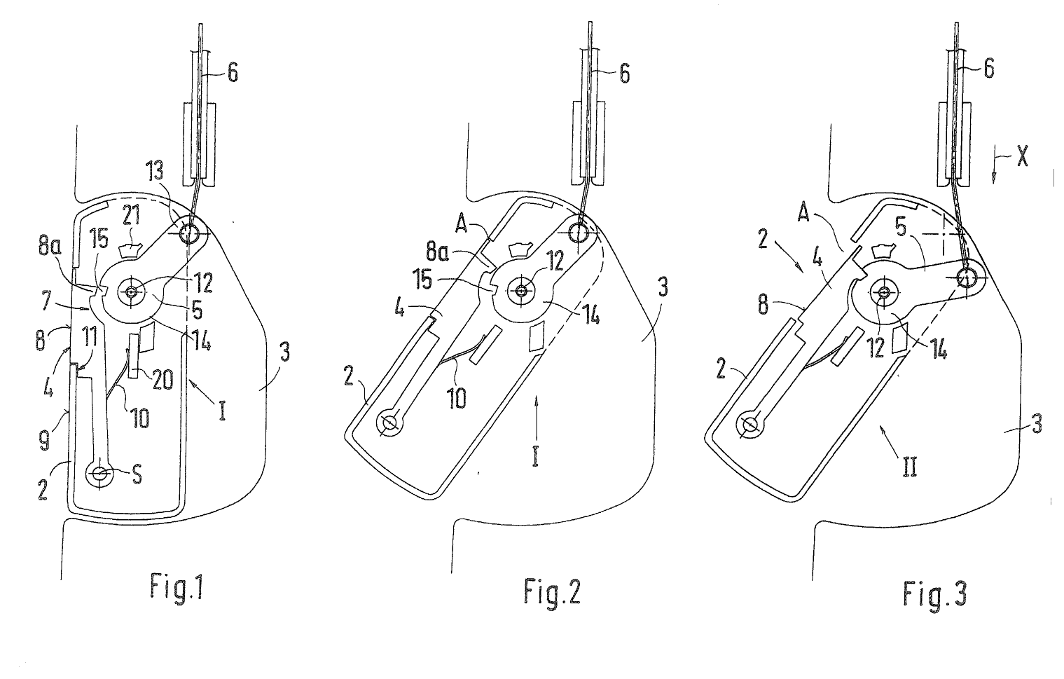

The locking sensing device 4 does not mesh with the catch element 5 in the locking position I of the hood, as shown in FIGS. 1 and 2. In an actuating position II, the locking sensing device 4 meshes with the catch element 5, as shown in FIG. 3, and thus the hood can be opened.

The locking sensing device 4 includes an elongated lever, and one end of the locking sensing device 4 is held in a swiveling manner in a seat 5. The free end 7 in the handle 2 has an outer sensing surface 8 with an interior catch nose 8a. This sensing surface 8 is seated in a section A of the handle and runs flush with the outer surface 9 of the handle 2. The locking sensing device 4 is held in a flush position in the section A of the handle with a spring device 10, such as a leaf spring, as shown in FIG. 1. The spring device 10 rests against the stop 20. The sensing surface 8 or the locking sensing device 4 is supported in the handle 2 by a support device 11. The support device 11 includes a protrusion on the locking sensing device 4, which protrusion reaches under a rim of the handle 2.

The catch element 5 includes a lever, which can be adjusted on a swiveling axis 12 in the handle 2. On the free end 13 of the lever, the Bowden cable 6 is fastened. A catch recess 15 is arranged in a seating part 14, which surrounds the swiveling axis 12. This recess 15 meshes with the catch nose 8 of the locking sensing device 4.

As shown in FIG. 1, the handle 2 is completely disposed in the trough 3, and the catch nose 8a does not mesh with the catch recess 15. As shown in FIG. 2, the hood cannot be opened and/or the Bowden cable 6 cannot be pulled by swiveling the handle 2 because the catch nose 8a does not mesh with the locking sensing device 4. In this way the hood cannot be opened from the outside and misuse is prevented.

By pressing the sensing surface 8 of the locking sensing device 4 in the direction of the arrow Z in a position of the handle 2 in the trough 3 pursuant to FIG. 1, the nose 8a meshes with the catch recess 15. The Bowden cable 6 is pulled in the direction of the arrow X by swiveling the handle 2 out so that the hood lock can be unlocked. After releasing the locking sensing device 4, the hood lock can be locked again by allowing the catch element 5 to assume its basic position pursuant to FIG. 1. This position is supported at the stop 21.

1. An actuating device for a hood of a motor vehicle, the hood having a locking mechanism, the device comprising:
a catch element connected to the locking mechanism using a cable; and
a handle including:
an integrated locking sensing device having a locking position where the integrated locking sensing device is disengaged with the catch element, and the integrated locking sensing device also having an actuating position where the integrated locking sensing device is engaged with the catch element, wherein when the integrated locking sensing device is in the locking position, the handle cannot be used to move the catch element to unlock the hood, and wherein when the integrated locking sensing device is in the actuating position, the handle can be used to move the catch element to unlock the hood, and
a spring device biasing the integrated locking sensing device towards the locking position.

2. The actuating device according to claim 1, wherein the integrated locking sensing device has a nose, and the catch element has a catch recess, wherein when the integrated locking sensing device is in the actuating position, the nose meshes with the catch recess to engage the integrated locking sensing device with the catch element, and wherein when the integrated locking sensing device is in the locking position, the nose does not mesh with the catch recess to disengage the integrated locking sensing device with the catch element.

3. The actuating device according to claim 2, wherein in the locking position the integrated locking sensing device is arranged flush with an outer surface of the handle.

4. The actuating device according to claim 2, wherein the handle having a support structure, and wherein the integrated locking sensing device is held in the support structure by the spring device, when the integrated locking sensing device is in the locking position.

5. The actuating device according to claim 2, wherein the integrated locking sensing device includes an elongated lever that can swivel about an axis in the handle.

6. The actuating device according to claim 2, wherein the catch element includes a lever having a seating part and a free end, the catch recess being positioned at the seating part, and wherein the seating part of the lever is rotatably mounted to the handle at an axis so that the lever can swivel about the axis, and the free end of the lever is connected to the cable.

7. The actuating device according to claim 2, wherein the lever of the catch element rests against a stop of the handle in the locking position.

8. The actuating device according to claim 1, wherein in the locking position the integrated locking sensing device is arranged flush with an outer surface of the handle.

9. The actuating device according to claim 1, wherein the handle having a support structure, and wherein the integrated locking sensing device is held in the support structure by the spring device, when the integrated locking sensing device is in the locking position.

10. The actuating device according to claim 1, wherein the integrated locking sensing device includes an elongated lever that can swivel about an axis in the handle.

11. The actuating device according to claim 1, wherein the catch element includes a lever having a seating part and a free end, the catch recess being positioned at the seating part, and wherein the seating part of the lever is rotatably mounted to the handle at an axis so that the lever can swivel about the axis, and the free end of the lever is connected to the cable.

12. The actuating device according to claim 1, wherein the lever of the catch element rests against a stop of the handle in the locking position.

13. A method for unlocking a hood of a motor vehicle using an actuating device, the hood having a locking mechanism, the device including a catch element connected to the locking mechanism using a cable, and a handle having an integrated locking sensing device having a locking position where the integrated locking sensing device is disengaged with the catch element, and the integrated locking sensing device also having an actuating position where the integrated locking sensing device is engaged with the catch element, wherein when the integrated locking sensing device is in the locking position, the handle cannot be used to move the catch element to unlock the hood, and wherein when the integrated locking sensing device is in the actuating position, the handle can be used to move the catch element to unlock the hood, the method comprising:
placing the integrated locking sensing device in the actuating position so that the integrated locking sensing device is engaged with the catch element; and
turning the handle to unlock the hood.
